(19) United States
(12) Patent Application Publication
(10) Pub. No.: US 2004/0265515 A1
(43) Pub. Date: Dec. 30, 2004

(54) Ink-receiving material

(75) Inventors: Stefaan Lingier, Assenede (BE); Huub Van Aert, Pulderbos (BE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: AGFA-GEVAERT, Mortsel (BE)

(21) Appl. No.: 10/876,050

(22) Filed: Jun. 24, 2004

Related U.S. Application Data
(60) Provisional application No. 60/487,825, filed on Jul. 16, 2003.

(30) Foreign Application Priority Data
Jun. 25, 2003 (EP) 03101868.2

(51) Int. Cl. B41M 5/00

(52) U.S. Cl. 428/32.34

(57) ABSTRACT

An ink-receiving material comprising a support coated on at least one side with an ink-receiving layer, the ink-receiving layer containing silica with a primary particle size between 7 and 40 nm and an at least partially hydrolyzed copolymer comprising vinyl ester and ethylenically unsaturated cationic monomer units hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt; and a process for the preparation of an ink-receiving material comprising the steps of: coating a support on at least one side with a dispersion containing sub-micron silica particles, an at least partially hydrolyzed copolymer comprising vinyl ester monomer units, ethylenically unsaturated cationic monomer units and boric acid or a borate, thereby preparing an ink-receiving layer hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt.

### CROSS-REFERENCE TO RELATED PATENT APPLICATIONS

This application claims the benefit of U.S. Provisional Application No. 60/487,825 filed Jul. 16, 2003, which is incorporated by reference. In addition, this application claims the benefit of European Application No. 03101868.2 filed Jun. 25, 2003, which is also incorporated by reference.

### FIELD OF THE INVENTION

The present invention relates to an improved ink-receiving material for ink jet printing.

### BACKGROUND OF THE INVENTION

In the majority of applications printing proceeds by pressure contact of an ink-laden printing form with an ink-receiving material which is usually plain paper. The most frequently used impact printing technique is known as lithographic printing based on the selective acceptance of oleophilic ink on a suitable receptor. In recent times however so-called non-impact printing systems have replaced classical pressure-contact printing to some extent for specific applications. A survey is given e.g. in the book “Principles of Non Impact Printing” by Jerome L. Johnson (1986), Palatino Press, Irvine, Calif. 92715, USA.

Among non-impact printing techniques ink jet printing has become a popular technique because of its simplicity, convenience and low cost. Especially in those instances where a limited edition of the printed matter is needed ink jet printing has become a technology of choice. A recent survey on progress and trends in ink jet printing technology is given by Hue P. Lee in Journal of Imaging Science and Technology Vol. 42(1) (1998).

Ink-receiving materials for ink-jet printing must fulfil a number of stringent requirements. They contain an ink-receiving layer or ink-receiving layers which should fulfil the following requirements: a high ink-absorbing capacity, so that the dots will not flow out and will not be expanded more than is necessary to obtain a high optical density; a high ink absorbing speed (short ink drying time) so that the ink droplets will not feather if smeared immediately after applying; ready wetting by the ink so that there is no “puddling”, i.e. coalescence of adjacent ink dots; no “bleeding” i.e. overlap with neighbouring or later placed dots; and no surface cracking. Furthermore, the ink-receiving material should not exhibit curl or sticky behaviour upon stacking prior to printing; and should be able to be transported through different types of printer.

After printing the image on the ink-receiving material must exhibit good water-fastness, light-fastness, and good stability under severe conditions of temperature and humidity; and the print must not exhibit any curl or sticky behaviour upon stacked and should be able to move smoothly through different types of printers.

Furthermore, transparent ink-receiving materials must have a low haze-value and be excellent in transmittance properties.

It is difficult to fulfil all these requirements at the same time.

U.S. Pat. No. 3,889,270 discloses in a process for information recording comprising producing a fine jet of colored liquid, directing the jet of colored liquid onto a recording medium, modulating the density of the applied jet by an electric field in accordance with the information to be recorded, the improvement comprising the recording medium consisting of a support with an image-receiving layer, wherein the image-receiving layer is a molecular or colloidal disperse substance, which is wetted by the colored liquid and into which the colored liquid penetrates to a depth in the order of a few microns; and further discloses that the image receiving layer preferably comprises a protein, a polysaccharide, cellulose, a cellulose derivative, a polyvinyl alcohol, a copolymer of vinyl alcohols or a hydrophilic silica gel.

U.S. Pat. No. 4,440,827 discloses a process for producing a recording paper for ink jet recording and optical bar code printing having, on the surface of a support, a coating layer comprising an inorganic pigment and an aqueous polymeric binder characterized by obtaining said coating layer by twice or more repeating a coating step with the same coating color which comprises coating a coating color prepared by mixing 100 parts by weight of said inorganic pigment containing 50-100 parts by weight of synthetic silica with 5-18 parts by weight of said aqueous polymeric binder in an amount of 2-9 g solid/m² per one side of the support by one run of coating procedure and then drying the coating color.

EP-A 0 379 964 discloses a recording sheet for ink jet printers which print with an aqueous ink containing a water soluble dye consisting of a carrier of a material capable of ink absorption which is coated or impregnated with an ink receptive material which contains a mixture of an amorphous silicon dioxide and a cationic resin and further disclose that that the amorphous silicon dioxide is preferably one obtained by hydrolysis of silicon tetrachloride in an oxyhydrogen flame, which consists of aggregates of ball-shaped particles with an average particle size of 7-40 nm; and that the cationic-resin preferably is selected from the group consisting of polyethylene imines, polydimethyldiallyl ammonium salts, particularly chlorides, polyalkylene polyaminedicyanodiamido ammonium chlorides, polyalkylenepolyaminedicyanodiamido ammonium condensates, polyvinylpyridine halides, polymers of (meth)acrylamidoalkyl quaternary ammonium salts, polymers of (meth)acryloylalkyl quaternary ammonium salts, ω-chloro-poly(oxyethylene polymethylene quaternary ammonium salts), polyvinylbenzyl trimethyl ammonium salts and N-methylglycolchitosan and mixtures thereof. There is no disclosure in EP-A 0 379 964 of hydrolyzed copolymers vinyl ester and ethylenically unsaturated cationic monomer units.

EP-A 1 211 086 discloses a method for the preparation of an ink jet recording element comprising coating on top of a support a layer pack comprising, in order, (a) a layer containing a pigment at a solid weight % of 60 to 98 of the total solid weight of the layer, and (b) a layer containing a water-soluble polymer, characterized in that said layers (a) and (b) are coated simultaneously wet on wet; and further discloses that the preferred pigment is an inorganic pigment, preferably silica, and that the preferred polymer is a cationic polymer, is a nitrogen containing cationic polymer, preferably a nitrogen containing cationic polymer, which is preferably is copoly(vinylalcohol-vinylacetate-diallyldimethyl-ammonium chloride). EP-A 1 211 086 further discloses the use of hardening agents in the ink-receiving layers, which can be used individually or in combination and in free or in blocked form with the following hardeners being discloses: formaldehyde and free dialdehydes, such as succinaldehyde and glutaraldehyde, blocked dialdehydes, active esters, sulfonate esters, active halogen compounds, isocyanate or blocked isocyanates, polyfunctional isocyanates, melamine derivatives, s-triazines and diazines, epoxides, active olefins having two or more active bonds, carbodiimides, isoxazolium salts subsituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches and copoly(acroleinmethacrylic acid), and oxazoline functional polymers, e.g. EPOCROS WS-500, and EPOCROS K-1000 series.

EP-A 0 634 286 discloses a recording sheet comprising a substrate and a alumina hydrate layer formed thereon, wherein the alumina hydrate layer contains a polyvinyl alcohol in an amount of from 5 to 50 wt % relative to the alumina hydrate, and boric acid or borate in an amount of from 0.1 to 10 wt % as calculated as H₃BO₃ relative to the polyvinyl alcohol.

JN 05-104848 discloses an ink-jet recording paper formed by successively providing a borax or boric acid treatment layer and an ink-jet recording layer of 5 to 25 g/m² to the gloss surface of single-sided gloss paper, the ink-jet recording layer being formed from at least 100 parts by weight of pigment based on synthetic silica and 10 to 50 parts by weight of polyvinyl alcohol.

EP-A 0 493 100 discloses an ink jet recording paper comprising a substrate and an ink-jet recording layer formed thereon, characterized in that the substrate is coated with at least 0.1 g/m² of borax or boric acid on at least one face thereof, and in that the ink-jet recording layer is formed on the or one of the coated faces of the substrate at a coverage of 5-20 g/m² and comprises 100 parts by weight of a pigment having a synthetic silica as the main ingredient and 10-35 parts by weight of a binder having polyvinyl alcohol as the main ingredient.

EP-A 1 306 395A discloses a cationic polymer represented by the following general formula (A):

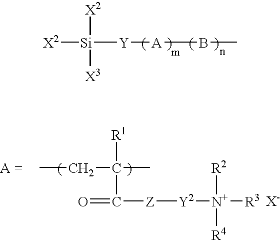

wherein X¹, X² and X³ each independently represent a hydrogen atom, or an alkyl group having 1 to 18 carbon atoms or an alkoxy group having 1 to 8 carbon atoms or an aryloxy group, each of which may contain a saturated or unsaturated cyclic structure; further, at least one of X¹, X² and X³ represents the alkoxy group or the aryloxy group; Y represents a bivalent linking group having 1 to 18 carbon atoms, which may have a substituent and may have therein a linking heteroatom; B represents at least one recurring unit which can be copolymerized with A; m and n represent the mole ratios of the A component and the B component, respectively, where 0.2≦m≦1.0, and 0.1≦n≦0.8 (m+n=1.0); R¹ represents a hydrogen atom or an alkyl group having 1 to 4 carbon atoms; R², R³ and R⁴ each independently represent a hydrogen atom, or an alkyl group having 1 to 18 carbon atoms, an aryl group or an aralkyl group, each of which may have a substituent and may be linked to form a saturated or unsaturated cyclic structure; Z represents —O— or —NH—; Y² represents a bivalent linking group having 1 to 8 carbon atoms, which may have therein a linking heteroatom; and X⁻ represents an anion.

US 2002/045032A discloses a process for manufacturing a recording medium for ink-jet recording, the process comprising the steps of: 1) supplying continuously at least inorganic particles and an aqueous medium to a disperser; 2) dispersing the inorganic particles in the disperser to obtain an inorganic particle dispersion solution; 3) ejecting continuously the dispersion solution from the disperser, wherein the supplying, dispersing, and ejecting are carried at the first dispersion stage; 4) providing a coating solution containing the resulting inorganic particle dispersion solution; and 5) coating the coating solution on a support.

EP 1 251 013A discloses an inkjet recording sheet comprising a support and, on a surface of the support, a colorant-receiving layer formed by: applying a first coating liquid, which has a pH value of at most 5 and is obtained by adding a solution that includes polyvinyl alcohol, a high boiling point organic solvent and at least one of a first nonionic surfactant and an amphoteric surfactant, to a dispersion that includes vapor-phase-process silica having a specific surface area of at least 200 m²/g as measured by the BET method and a cationic resin, to form a coat layer; adding, to the coat layer formed by the application of the first coating liquid, a second coating liquid, which has a pH value of at least 8.5 or higher and includes a cross-linking agent capable of cross-linking the polyvinyl alcohol, an organic mordant and a second nonionic surfactant, either at the same time as the application of the first coating liquid or during drying of the coat layer of the first coating liquid but before the coat layer shows a decreasing rate of drying; and thereafter allowing the coated layer, to which the second coating liquid has been added, to harden and dry for forming a porous structure.

EP 1 264 705A discloses a porous resin film comprising a thermoplastic resin, an inorganic and/or organic finely divided powder and a hydrophilicizer, wherein said porous resin film has a liquid absorption capacity in accordance with “Japan TAPPI No. 51-87” of 0.5 mI/m² or above and the ink-receiving layer has a surface glossinesss (JIS-Z8741: measuring method at 60°) of 40%$ or above.

US 2003/072925A discloses an ink-jet recording material which comprises a support and at least two ink-receptive layers containing inorganic fine particles and a hydrophilic binder provided by coating thereon, wherein an ink-receptive layer (A) nearer to the support contains fumed silica, and an ink-receptive layer (B) apart from the support contains alumina or alumina hydrate.

US 2001/004487A discloses an ink-jet recording material comprising a support, a layer containing at least one of a polymer latex and a resin emulsion, and solid fine particles provided on the support, and at least one layer containing fumed silica provided on the above-mentioned layer.

### ASPECTS OF THE INVENTION

It is therefore an aspect of the present invention to provide an ink-receiving material with reduced surface cracking.

It is therefore another aspect of the present invention to provide a process for preparing an ink-receiving material with reduced surface cracking.

It is therefore also an aspect of the present invention to provide a process for preparing an ink-receiving material comprising a support and an ink-receiving layer comprising a coating step with an increased latitude in waiting time prior to coating.

Further aspects and advantages of the invention will become apparent from the description hereinafter.

### SUMMARY OF THE INVENTION

In the preparation of ink-receiving layers comprising aluminium oxide hydrate, e.g. boehmite or pseudo-boehmite, a boric acid or borate-hardenable binder and boric acid or a borate, it was found that the potlife of the coating dispersion was long whether polyvinyl alcohol, hydrolyzed polyvinyl acetate (i.e. a copolymer of vinyl acetate and vinyl alcohol) or copoly(vinylalcohol-vinylacetate-diallyldimethylammonium chloride) was used as the binder. However, when sub-micron silica was used as the ink-absorbing pigment instead of aluminium oxide hydrate, the potlife of a dispersion containing boric acid or borate was surprisingly critically dependent upon whether polyvinyl alcohol or an at least partially hydrolyzed copolymer comprising vinyl ester monomer units and ethylenically unsaturated cationic monomer units was used. Furthermore, the hardening kinetics and hence the homogeneity of the hardening was surprisingly also critically dependent on whether polyvinyl alcohol or a hydrolyzed copolymer comprising vinyl ester and ethylenically unsaturated cationic monomer units was used. We have surprisingly found that, whereas if polyvinyl alcohol is used as the binder the viscosity of the coating dispersion immediately increases rapidly, if a hydrolyzed copolymer comprising vinyl ester and ethylenically unsaturated cationic monomer units was used there was no rapid increase in dispersion viscosity, thereby increasing the potlife of the coating dispersion. Furthermore, the hardening of the layer after coating proceeded more homogeneously resulting in reduced surface cracking of the layer. Moreover, the ink-receiving layers obtained with at least partially hydrolyzed copolymers comprising vinyl ester monomer units and ethylenically unsaturated cationic monomer units were much more transparent than those obtained with high molecular weight polyvinyl alcohol.

Aspects of the present invention are realized by an ink-receiving material comprising a support coated on at least one side with an ink-receiving layer, the ink-receiving layer containing sub-micron silica and an at least partially hydrolyzed copolymer comprising vinyl ester and ethylenically unsaturated cationic monomer units hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt.

Aspects of the present invention are also realized by a process for the preparation of an ink-receiving material comprising the steps of: coating a support on at least one side with a dispersion containing sub-micron silica particles, an at least partially hydrolyzed copolymer comprising vinyl ester monomer units, ethylenically unsaturated cationic monomer units and boric acid or a borate, thereby preparing an ink-receiving layer hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt.

Further aspects of the present invention are disclosed in the dependent claims.

### DETAILED DESCRIPTION OF THE INVENTION

### Definitions

Polyvinyl alcohol, as used in disclosing the present invention, means a partially or fully hydrolyzed polyvinyl ester e.g. polyvinyl acetate.

The term sub-micron silica particles, as used in disclosing the present invention, means silica particle with an average particle size of less than 1 μm.

The term an at least partially hydrolyzed copolymer comprising vinyl ester monomer units and ethylenically unsaturated cationic monomer units includes copolymers comprising vinyl ester monomer units and ethylenically unsaturated cationic monomer units which have been at least partially hydolyzed and copolymers of vinyl ester monomer units and vinyl precursor monomer units which have been at least partially hydrolyzed follows by functionalizing the precursor monomer units into ethylenically unsaturated cationic monomer units.

The term ink-pervious, as used in disclosing the present invention, means pervious to ink i.e. that ink can diffuse through.

### Ink-Receiving Layer

According to a first embodiment of the ink-receiving material, according to the present invention, the lower limit of the ratio by weight of the total binder to the total pigment in the ink-receiving layer is 1:50.

According to a second embodiment of the ink-receiving material, according to the present invention, the lower limit of the ratio by weight of the total binder to the total pigment in the ink-receiving layer is 1:20.

According to a third embodiment of the ink-receiving material, according to the present invention, the upper limit of the ratio by weight of the total binder to the total pigment in the ink-receiving layer is 1:2.

According to a fourth embodiment of the ink-receiving material, according to the present invention, the upper limit of the ratio by weight of the total binder to the total pigment in the ink-receiving layer is 1:1.

If the amount of the pigment exceeds the upper limit, the strength of the ink receiving layer itself is lowered, and the resulting image hence tends to deteriorate in rub-off resistance and the like. On the other hand, if the binder to pigment ratio is too great, the ink-absorbing capacity of the resulting ink-receiving layer is reduced, and so the image formed may possibly be deteriorated.

According to a fifth embodiment of the ink-receiving material, according to the present invention, the ink-receiving layer has a haze value of at most 45%.

According to a sixth embodiment of the ink-receiving material, according to the present invention, the ink-receiving layer is coated with a non-pigmented ink-pervious protective layer. This layer can also increase the gloss of the side or sides of the support onto which the ink-receiving layer has been coated.

### Support

The support for use in the present invention can be selected from the paper type supports and polymeric type supports well-known from photographic technology. Paper types include plain paper, cast coated paper, a paper carrying a barrier layer preventing ink penetration, polyethylene coated paper and polypropylene coated paper. Polymeric supports include cellulose acetate propionate or cellulose acetate butyrate, polyesters such as polyethylene terephthalate (PET) and polyethylene naphthalate, polyvinyl chloride, polyamides, polycarbonates, polyimides, polyolefins, poly(vinylacetals), polyethers and polysulfonamides. Other examples of useful high-quality polymeric supports for the present invention include opaque white polyesters and extrusion blends of polyethylene terephthalate and polypropylene. For transparent materials polyester film supports, and especially polyethylene terephthalate, are preferred because of their excellent properties of dimensional stability. For the practice of the present invention a resin coated paper support is preferred.

According to a seventh embodiment of the ink-receiving material, according to the present invention, the support is a transparent support.

According to an eighth embodiment of the ink-receiving material, according to the present invention, the support is a transparent polyester support.

According to a ninth embodiment of the ink-receiving material, according to the present invention, the support is a resin-coated paper.

### Silica

Sub-micron silica particles as used in the ink-receiving material, according to the present invention, can be amorphous or crystalline silica and can be prepared by liquid or gas phase processes e.g. spherical, non-spherical, colloidal, gel, precipitated and flame-pyrolyzed silicas.

According to a tenth embodiment of the ink-receiving material, according to the present invention, the silica has a primary particle size between 4 and 60 nm.

According to an eleventh embodiment of the ink-receiving material, according to the present invention, the silica has a primary particle size between 5 and 50 nm.

According to a twelfth embodiment of the ink-receiving material, according to the present invention, the silica has an average agglomerated particle size smaller than 500 nm.

Particularly suitable silicas for use in the ink-receiving material, according to the present invention, are:

| | | Specific | |
|---|---|---|---|
| | | surface | Primary particle |
| | Manufacturer | area* [m²/g] | size [nm] |
| HDK T30 | Wacker Chemie | 300 | 7 |
| HDK T40 | Wacker Chemie | 400 | 5 |
| AEROSIL ® 200 | Degussa | 200 | 12 |
| AEROSIL ® 300 | Degussa | 300 | 7 |
| AEROSIL ® 380 | Degussa | 380 | 7 |
| CAB-O-SPERSE | Cabot Corporation | 200 | 20 (TEM) |
| PG0022# | | | |

*via BET method
#cationic type

Before combining these silica's with the at least partially hydrolyzed copolymer comprising vinyl ester monomer units and ethylenically unsaturated cationic monomer units the surface charge of the aggregate particles are preferably changed from negative to positive. The surface charge can be changed via several methods. An alternative for the silica treatment of commercial available fumed silica is obtaining directly form a commercial source an aqueous dispersion of cationically modified fumed silica. An example of a commercial available grade is CAB-O-SPERSE PG0022. This silica dispersion has a solids content of 20%, a pH=3.8 and a positive zeta potential (+35 mV). CAB-O-SPERSE PG0022 is available from Cabot Corporation.

Methods of preparing fine particles of cationized silica include:

(1) silica subjected to a surface treatment with a compound containing some of the cationic metal oxides or metal atoms as described above; an example of such preparation route is described in the following reference:

Cationic silica dispersion for recording material: Field, Rex J.; Darsillo, Michael S.; Fluck, David J.; Laufhutte, Rudige (Cabot Corporation, USA) in WO 00/20221;

Recording medium excellent in ink absorptivity and process for its production, and process for producing silica-alumina composite sol: Nakahara, Katsumasa; Inokuma, Hisao; Hirano, Hachirou; Matsubara, Toshiya; Wakabayashi, Masako; Kon, Yoshinori (Asahi Glass Company Ltd., Japan) in EP 1112962A1;

Ink-receptive coating for ink-jet recording material: Chapman, David Monroe (W.R. Grace & Co. —Conn., USA) in WO 00/02736;

(2) silica subjected to a surface treatment with an organic compound having both amino group or quaternary ammonium group thereof and functional group having reactivity to a silanol group on the surface of silica, such as aminoethoxysilane or aminoalkyl glycidyl ether or isopropanol amine, examples of such preparation routes are described in:

Ink-jet printing ink-accepting compositions comprising cation-modified silica, vinyl polymers and cationic polymers for printing fabrics using ink-jet printers with high color depth and printing fabrics coated or impregnated with the compositions: Yasuda, Masahiro; Okudo, Toshifumi; Hirota, Yasuhide (Kyoeisha Chemical Co., Ltd., Japan) in JP-A 2000265380;

Ink-jet-printable image-transfer medium, process for transferring image, and cloth imaged by this process: Sato, Yuko; Higuma, Masahiko; Shino, Yoshiyuk (Canon Kabushiki Kaisha, Japan) in EP 933225A1;

Adsorption of cationic surfactants on highly dispersed silica: Mikhailova, I. V.; Gerashchenko, I. I. (Institute of Surface Chemistry, National Academy of Sciences of Ukraine, Kiev, Ukraine) in Colloid J. (2001), 63(4), 437-440;

Functionalization of silica particles towards cationic polyelectrolytes using vinylformamide and 1,3-divinylimidazolidin-2-one as monomers: Meyer, Torsten; Rehak, Petra; Jager, Christian; Voigt, Ina; Simon, Frank; Spange, Stefan (Polymer Chemistry, Institute for Chemistry, Chemnitz University of Technology, Chemnitz, Germany) in Macromol. Symp. (2001), 163 (Tailormade Polymers), 87-96.

Image receiving element and method of manufacturing the element: Yarmey, Susan K.; Steiner, Michael L. (Imation Corp., USA) in WO 01/05599;

Coated paper with good printability for ink-jet printing. Hirose, Mifune; Sakaki, Mamoru; Katayama, Masato; Higuma, Masahiko; Moriya, Kenichi; Nishioka, Yuko (Canon K. K., Japan) in EP 732219A2;

Manufacture of porous, laminar, inorganic products: Yokoyama, Masaru; Hirao, Shozo; Kishimoto, Takashi; Takahama, Koichi (Matsushita Electric Works, Ltd., Japan) in JP-A 62176969;

(3) polymerisation of a cationic or amino functional monomer in the presence of a silica, e.g. as descibed in:

Ink-jet printing sheet containing cationic silica: Ito, Hiroshi; Sawamoto, Hidetada; Hasegawa, Makoto (Oji Paper Co., Ltd., Japan) in JP-A 2001293948;

Grafting of polymers with controlled molecular weight onto carbon black and ultrafine silica surface: Tsubokawa, Norio; and Yoshikawa, Sachio (Department of Material Science and Technology, Faculty of Engineering, Niigata University, Niigata, Japan) in Recent Res. Dev. Polym. Sci. (1998), 2(Pt. 2), 211-228;

Cationic polymer synthesis at inorganic surfaces: Spange, S. (Inst. Org. Chem. Macromol. Chem., Jena Univ., Jena, Germany) in Vysokomol. Soedin., Ser. A Ser. B (1993), 35(11), 1873-7.

### Boric Acid and Borate

Boric acid or borate e.g. borax have the function in the ink-receiving layer of crosslinking the at least partially hydrolyzed copolymers comprising vinyl ester monomer units and ethylenically unsaturated cationic monomer units.

### Further Pigments

According to a thirteenth embodiment of the ink-receiving material, according to the present invention, the ink-receiving layer contains a further pigment. Suitable further pigments for incorporation into the ink-receiving layer are: kaolin, talc, clay, hydrotalcite, diatomaceous earth, calcium carbonate, barium sulphate, titanium dioxide, magnesium carbonate, basic magnesium carbonate, aluminosilicate, aluminum trihydroxide, aluminum oxide (alumina), titanium oxide, zinc oxide, barium sulfate, calcium sulfate, zinc sulfide, satin white, an aluminium oxide hydrate e.g. boehmite or pseudo-boehmite, zirconium oxide, silica with an average particle size greater than 1 μm or mixed oxides.

According to a fourteenth embodiment of the ink-receiving material, according to the present invention, the further pigment is selected from the group consisting of aluminosilicate, alumina, calcium carbonate, aluminium oxide hydrate, aluminum trihydroxide and mixtures thereof.

Commercially available types of aluminum oxide (alumina) include α-Al₂O₃ types, such as NORTON E700, available from Saint-Gobain Ceramics & Plastics, Inc, γ-Al₂O₃ types, such as ALUMINUM OXID C from Degussa, Other Aluminum oxide grades, such as BAIKALOX CR15 and CR30 from Baikowski Chemie; DURALOX grades and MEDIALOX grades from Baikowski Chemie, BAIKALOX CR80, CR140, CR125, B105CR from Baikowski Chemie; CAB-O-SPERSE PG003 trademark from Cabot, CATALOX GRADES and CATAPAL GRADES from Sasol, such as PLURALOX HP14/150; colloidal Al₂O₃ types, such as ALUMINASOL 100; ALUMINASOL 200, ALUMINASOL 220, ALUMINASOL 300, and ALUMINASOL 520 trademarks from Nissan Chemical Industries or NALCO 8676 trademark from ONDEO Nalco.

A useful type of alumina hydrate is γ-AlO(OH), also called boehmite, available in powder form as DISPERAL, DISPERAL HP14 and DISPERAL 40 from SASOL, MARTOXIN VPP2000-2 and GL-3 from MARTINSWERK GmbH. and as liquid boehmite alumina systems as DISPAL 23N4-20, DISPAL 14N-25, DISPERAL AL25 from SASOL.

Useful aluminum trihydroxides include Bayerite, or α-Al(OH)₃, such as PLURAL BT, available from SASOL, and Gibbsite, or γ-Al(OH)₃, such as MARTINAL grades from MARTINSWERK GmbH, MARTIFIN grades, such as MARTIFIN OL104, MARTIFIN OL 107 and MARTIFIN OL111 from Martinswerk GmbH , MICRAL grades, such as MICRAL 1440, MICRAL 1500; MICRAL 632; MICRAL 855; MICRAL 916; MICRAL 932; MICRAL 932CM; MICRAL 9400 from JM Huber company; HIGILITE grades, e.g. HIGILITE H42 or HIGILITE H43M from Showa Denka K. K., HYDRAL GRADES such as HYDRAL COAT 2, HYDRAL COAT 5 and HYDRAL COAT 7, HYDRAL 710 and HYDRAL PGA, from ALCOA Industrial Chemicals.

A useful type of zirconium oxide is NALCO OOSS008 trademark of ONDEO Nalco, acetate stabilized ZrO2, ZR20/20, ZR50/20, ZR100/20 and ZRYS4 trademarks from Nyacol Nano Technologies.

Useful mixed oxides are SIRAL grades from SASOL, colloidal metal oxides from NALCO such as Nalco 1056, Nalco TX10496, Nalco TX11678.

The use of calcium carbonate in ink receiving layers is described in e.g. DE 2925769 and U.S. Pat. No. 5,185,213. The use of alumino-silicate is disclosed in e.g. DE 2925769.

According to a fifteenth embodiment of the ink-receiving material, according to the present invention, the ink-receiving layer contains an organic pigment. The organic pigment can be selected from the group consisting of polystyrene, polymethyl methacrylate, silicones, melamine-formaldehyde condensation polymers, urea-formaldehyde condensation polymers, polyesters and polyamides.

Mixtures of different inorganic pigments may be used and mixtures of inorganic and organic pigments can also be used.

### Hydrolyzed Copolymers Comprising Vinyl Ester and Ethylenically Unsaturated Cationic Monomer Units

The at least partially hydrolyzed copolymers comprising vinyl ester monomer units and ethylenically unsaturated cationic monomer units, according to the present invention, can be prepared by direct copolymerization and subsequent hydrolysis or by copolymerisation of a precursor for a cationic monomer with vinyl acetate, subsequent hydrolysis and then conversion of the precursor group into a cationic monomer unit.

According to a sixteenth embodiment of the ink-receiving material, according to the present invention, the N,N-dialkenyl-N,N-dialkyl ammonium salt is diallyl dimethylammonium chloride.

According to a seventeenth embodiment of the ink-receiving material, according to the present invention, the at least partially hydrolyzed copolymer comprising vinyl ester monomer units and ethylenically unsaturated cationic monomer units is a terpolymer of vinyl alcohol, vinyl acetate and diallyl dimethylammonium chloride.

Suitable ethylenically unsaturated cationic monomer units, according to the present invention, are given below:

| Monomer nr | |
|---|---|
| M1 | diallyldimethylammonium chloride |
| M2 | diallyldimethylammonium bromide |
| M3 | diallyldimethylammonium acetate |
| M4 | diallyldimethylammonium sulphonate |
| M5 | diallyldiethylammonium chloride |
| M6 | diallyldiethylammonium bromide |
| M7 | diallyldiethylammonium acetate |
| M8 | diallyldiethylammonium sulphonate |
| M9 | diallylethylmethylammonium chloride |
| M10 | diallylethylmethylammonium bromide |
| M11 | diallylethylmethylammonium acetate |
| M12 | diallylethylmethylammonium sulphonate |
| M13 | diallyl-di-n-propylammonium chloride |
| M14 | diallyl-di-n-propylammonium bromide |
| M15 | diallyl-di-n-propylammonium acetate |
| M16 | diallyl-di-n-propylammonium sulphonate |
| M17 | diallyl-di-iso-propylammonium chloride |
| M18 | diallyl-di-iso-propylammonium bromide |
| M19 | diallyl-di-iso-propylammonium acetate |
| M20 | diallyl-di-iso-propylammonium sulphonate |
| M21 | dimethyldivinylammonium chloride |
| M22 | diethyldivinylammonium chloride |
| M23 | di-n-propyl-divinylammonium chloride |
| M24 | di-isopropyldivinylammonium chloride |

These monomers can be prepared using conventional organic synthesis techniques well known to one skilled in the art.

The hydrolyzed copolymers comprising vinyl ester and ethylenically unsaturated cationic monomer units, according to the present invention, may be obtained by several routes:

1) copolymerisation of vinyl acetate with a cationic monomer and subsequent hydrolysis. Preferred cationic monomers are quaternary ammonium salts or phosponium salts, such as methacryloxyethyl trimethyl ammonium chloride, diallyldimethylammonium chloride and acryloxyethyl trimethyl ammonium chloride. Examples of such copolymerisations are described in the following reference:

Functional modification of poly(vinyl alcohol) by copolymerization. III. Modification with cationic monomers. Moritani, Tohei; Yamauchi, Junnosuke (Technical Research Center, Kuraray Company, Okayama, Japan) in Polymer (1998), 39(3), 559-572.

2) copolymerisation of a precursor for a cationic monomer with vinyl acetate and subsequent hydrolysis. Precursors for a cationic monomer include primary amines, secondary amines and tertairy amines, which become cationic after protonation, e.g. 2-(dimethylamino)ethyl methacrylate. Other precursors for cationic monomers are precursors for amino functional monomers such as vinyl acetamide. This route towards amino functional PVA is described in the following patents:

JP-A 2001081128 from Fujiwara, Naoki; Sato, Kazuaki; Matsumoto, Yoichi; Nakahara, Fumio (Kuraray Co., Ltd., Japan), entitled: Manufacture of vinyl alcohol polymers by saponification;

EP 617166 from Robeson, entitled: Amine-functional poly(vinyl alcohol) for improving properties of recycled paper;

JP-A 03281607 from Noguchi, Yasunori; Kadota, Takashi (Sakamoto Yakuhin Kogyo Co., Ltd., Japan), entitled: Preparation of cationic derivatives of poly(vinyl alcohol);

DE 3626662C1 from Stober, Reinhard; Kohn, Ellen; Bischoff, Dietmar (Degussa A.-G., Fed. Rep. Ger.), entitled: Preparation of cationic derivatives of poly(vinyl alcohol);

3) Derivatization of polyvinylalcohol yielding amino, quaternary ammonium or quaternary phosphonium functional polymers, e.g. via esterification, etherification or acetalisation. Useful reagents for this purpose are e.g. 4-aminobutyraldehyde dimethyl acetal, aminoacetaldehyde, glycidyltrimethylammonium chloride, etc. Examples of such modifications are described in the following patents:

U.S. Pat. No. 5,397,436 from Robeson, Lloyd M.; Davidowich, George; Pinschmidt, Robert K., Jr. (Air Products and Chemicals, Inc., USA), entitled: Paper wet-strength improvement with cellulose reactive size and amine-functional poly(vinyl alcohol) and paper from;

DE 4438004A1 from Helling, Guenter; Peters, Manfred. (Agfa-Gevaert AG, Germany), entitled: Photographic film with improved light stability;

EP 627656 from Helling, Guenter; Dewanckele, Jean-Marie (Agfa-Gevaert AG, Germany), entitled: Photographic recording material.

4) An amino modified polyvinylalcohol prepared from a graft copolymerisation of amino-modified monomers with polyvinyl alcohol. The amino-functional monomer can have primairy, secondary, tertiary or quaternary amine groups. An example of a such graft copolymerisations is described by Celanese in:

WO 01/74599 from Rabasco, John Joseph; Klingenberg, Eric Howard; Boylan, John Richard. (Celanese International Corporation, USA), entitled: Ink receptive coating compositions containing poly(vinyl alcohol) grafted with amine functional groups;

DE 19526626 from Denzinger, Walter; Ruebenacker, Martin; Nilz, Claudia; Lorencak, Primoz; Moench, Dietmar; Schuhmacher, Rudolf; Stange, Andreas (BASF AG., Germany), entitled: Graft polymers based on vinyl ester and/or alcohol polymers and ethylenically unsaturated monomers, their preparation and their use.

Suitable at least partially hydrolyzed copolymers comprising vinyl ester monomer units and ethylenically unsaturated cationic monomer units include:

| | | | | viscosity of 4 | Degree of |
|---|---|---|---|---|---|
| Copolymer | | | | wt % solution | hydrolysis |
| nr. | Name | CAS No. | Comonomer | [mPa · s] | [mol %] |
| 1 | GOHSEFIMER | 116141-66-3 | M1 | 18-22 | 85.5-88.0 |
| | K210# | | ca. 2 mol % | | |
| 2 | GOHSEFIMER | 116141-66-3 | M1 > 2 mol % | 27-33 | 85.5-89.0 |
| | OKS6010# | | | | |
| 3 | GOHSEFIMER | 116141-66-3 | M1 | 4.5-6.5 | 85.5-89.0 |
| | OKS6011# | | ca. 2 mol % | | |
| 4 | GOHSEFIMER | 116141-66-3 | M1 < 2 mol % | 4.5-6.5 | 85.5-89.0 |
| | OKS6012# | | | | |

#from Nippon Goshei

### Further Binder

According to an eighteenth of the ink-receiving material, according to the present invention, the ink-receiving layer contains a further binder.

According to a nineteenth embodiment of the ink-receiving material, according to the present invention, the ink-receiving layer further contains polyvinyl alcohol.

Suitable further binders for incorporating into the ink-receiving layer are: hydroxyethyl cellulose; hydroxypropyl cellulose; hydroxyethylmethyl cellulose; hydroxypropyl methyl cellulose; hydroxybutylmethyl cellulose; methyl cellulose; sodium carboxymethyl cellulose; sodium carboxymethylhydroxethyl cellulose; water soluble ethylhydroxyethyl cellulose; cellulose sulfate; polyvinyl alcohol; vinylalcohol copolymers; polyvinyl acetate; polyvinylacetal; polyvinyl pyrrolidone; polyacrylamide; acrylamide/acrylic acid copolymer; poly(styrene), styrene copolymers; acrylic or methacrylic polymers; styrene/acrylic copolymers; ethylene-vinylacetate copolymer; vinylmethyl ether/maleic acid copolymer; poly(2-acrylamido-2-methyl propane sulfonic acid); poly(diethylene triamine-co-adipic acid); polyvinyl pyridine; polyvinyl imidazole; polyimidazoline quaternized; polyethylene imine epichlorohydrin modified; polyethylene imine ethoxylated; poly(N,N-dimethyl-3,5-dimethylene piperidinium chloride; polyethylene oxide; polyurethane; melamine resins; gelatin; carrageenan; dextran; gum arabic; casein; pectin; albumin; starch; collagen derivatives; collodion and agar-agar.

### Adhesion

According to a twentieth embodiment of the ink-receiving material, according to the present invention, an adhesive undercoat layer may be incorporated, on one or both sides of the support, between the support and the ink-receiving layer. This layer is then coated from an aqueous medium containing any of the numerous known adhesive polymers. Preferred adhesive polymers include styrene-butadiene latex, acrylate latices, poly(ethylene-vinylacetate), polyvinylesters, copolyesters, polyesters and polyurethanes. Furhermore, the adhesive polymers include WAC series, such as WAC-10, WAC-15, WAC-17X and WAC-20, trademarks of Takamatsu Oil & Fat Co. The dry coating weight of this undercoat layer when present is preferably comprised between 0.5 and 5.0 g/m².

### Cationic Mordant

According to a twenty-first embodiment of the ink-receiving material, according to the present invention, the ink-receiving layer further contains a cationic compound acting as mordant. Such substances increase the capacity of the layer for fixing and holding the dye of the ink droplets. A particularly suited compound is a poly(diallyldimethylammonium chloride) or, in short, a poly(DADMAC). These compounds are commercially available from several companies, e.g. Aldrich, Nalco, CIBA, Nitto Boseki Co., Clariant, BASF and EKA Chemicals.

Other useful cationic compounds include DADMAC copolymers such as copolymers with acrylamide, e.g. NALCO 1470 trade mark of ONDEO Nalco or PAS-J-81, trademark of Nitto Boseki Co., such as copolymers of DADMAC with acrylates, such as Nalco 8190, trademark of ONDEO Nalco; copolymers of DADMAC with SO₂, such as PAS-A-1 or PAS-92, trademarks of Nitto Boseki Co., copolymer of DADMAC with maleic acid, e.g. PAS-410, trademark of Nitto Boseki Co., copolymer of DADMAC with diallyl(3-chloro-2-hydroxypropyl)amine hydrochloride, e.g. PAS-880, trademark of Nitto Boseki Co., dimethylamine-epichlorohydrine copolymers, e.g. Nalco 7135, trademark of ONDEO Nalco or POLYFIX 700, trade name of Showa High Polymer Co.; other POLYFIX grades which could be used are POLYFIX 601, POLYFIX 301, POLYFIX 301A, POLYFIX 250WS, and POLYFIX 3000; NEOFIX E-117, trade name of Nicca Chemical Co., a polyoxyalkylene polyamine dicyanodiamine, and REDIFLOC 4150, trade name of EKA Chemicals, a polyamine; MADAME (methacrylatedimethylaminoethyl=dimethylaminoethyl methacrylate) or MADQUAT (methacryloxyethyl-trimethylammonium chloride) modified polymers, e.g. ROHAGIT KL280, ROHAGIT 210, ROHAGIT SL144, PLEX 4739L, PLEX 3073 from Röhm, DIAFLOC KP155 and other DIAFLOC products from Diafloc Co., and BMB 1305 and other BMB products from EKA chemicals; cationic epichlorohydrin adducts such as POLYCUP 171 and POLYCUP 172, trade names from Hercules Co.; from Cytec industries: CYPRO products, e.g. CYPRO 514/515/516, SUPERFLOC 507/521/567; cationic acrylic polymers, such as ALCOSTAT 567, trademark of CIBA, cationic cellulose derivatives such as CELQUAT L-200, H-100, SC-240C, SC-230M, trade names of Starch & Chemical Co., and QUATRISOFT LM200, UCARE polymers JR125, JR400, LR400, JR30M, LR30M and UCARE polymer LK; fixing agents from Chukyo Europe: PALSET JK-512, PALSET JK512L, PALSET JK-182, PALSET JK-220, WSC-173, WSC-173L, PALSET JK-320, PALSET JK-320L and PALSET JK-350; polyethyleneimine and copolymers, e.g. LUPASOL, trade name of BASF AG; triethanolamine-titanium-chelate, e.g. TYZOR, trade name of Du Pont Co.; copolymers of vinylpyrrolidone such as VIVIPRINT 111, trade name of ISP, a methacrylamido propyl dimethylamine copolymer; with dimethylaminoethylmethacrylate such as COPOLYMER 845 and COPOLYMER 937, trade names of ISP; with vinylimidazole, e.g. LUVIQUAT CARE, LUVITEC 73W, LUVITEC VPI55 K18P, LUVITEC VP155 K72W, LUVIQUAT FC905, LUVIQUAT FC550, LUVIQUAT HM522, and SOKALAN HP56, all trade names of BASF AG; polyamidoamines, e.g. RETAMINOL and NADAVIN, trade marks of Bayer AG; phosphonium compounds such as disclosed in EP 609930 and other cationic polymers such as NEOFIX RD-5, trademark of Nicca Chemical Co.

### Further Crosslinking Agents

According to a twenty-second embodiment of the ink-receiving material, according to the present invention, further crosslinking agents are added to the ink-receiving layer and the optional backing and/or adhesive layers e.g. to provide such desired features as waterfastness and non-blocking characteristics. Crosslinking is also useful in providing abrasion resistance and resistance to the formation of fingerprints on the element as a result of handling. Crosslinking agents, otherwise known as hardening agents, can be used individually or in combination and in free or in blocked form.

According to a twenty-third embodiment of the ink-receiving material, according to the present invention, further crosslinking agents selected from the group consisting of formaldehyde, free dialdehydes, such as succinaldehyde and glutaraldehyde, blocked dialdehydes, active esters, sulfonate esters, active halogen compounds, isocyanates, blocked isocyanates, polyfunctional isocyanates, melamine derivatives, s-triazines, diazines, epoxides, active olefins having two or more active bonds, carbodiimides, zirconium complexes, e.g. BACOTE 20, ZIRMEL 1000 or zirconium acetate, trademarks of MEL Chemicals, titanium complexes, such as TYZOR grades from DuPont, isoxazolium salts substituted in the 3-position, esters of 2-alkoxy-N-carboxy-dihydroquinoline, N-carbamoylpyridinium salts, hardeners of mixed function, such as halogen-substituted aldehyde acids (e.g. mucochloric and mucobromic acids), onium substituted acroleins and vinyl sulfones and polymeric hardeners, such as dialdehyde starches, copoly(acroleinmethacrylic acid), oxazoline functional polymers, e.g. EPOCROS WS-500, and EPOCROS K-1000 series, and maleic anhydride copolymers, e.g. GANTREZ AN119.

### Stabilizers

According to a twenty-fourth embodiment of the ink-receiving material, according to the present invention, the ink receiving layer and optional extra layers further contain(s) at least one stabilizer e.g. against light and oxidation.

Such stabilizers include ingredients to improve the lightfastness of the printed image, such as antioxidants, UV-absorbers, peroxide scavengers, singlet oxygen quenchers such as hindered amine light stabilizers, (Hals compounds) etc. Stilbene compounds are a preferred type of UV-absorber.

### Plasticizers

According to a twenty-fifth embodiment of the ink-receiving material, according to the present invention, the ink receiving layer and optional extra layers further contain(s) at least one plasticizer e.g. ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalicanhydride, urea phosphate, triphenylphosphate, glycerolmonostearate, propylene glycol monostearate, tetramethylene sulfone, n-methyl-2-pyrrolidone, n-vinyl-2-pyrrolidone and butyl carbitol.

### Further Ingredients

According to a twenty-sixth embodiment of the ink-receiving material, according to the present invention, the ink receiving layer and the optional supplementary layers further contains a surfactant.

According to a twenty-seventh embodiment of the ink-receiving material, according to the present invention, the ink receiving layer and the optional supplementary layers further contains a whitening agent.

According to a twenty-eighth embodiment of the ink-receiving material, according to the present invention, the ink receiving layer and the optional supplementary layers further contain a matting agent.

Surfactants may be incorporated in the layers of the recording element of the present invention. They can be any of the cationic, anionic, amphoteric, and non-ionic ones as described in JP-A 62-280068 (1987). Examples of the surfactants are N-alkylamino acid salts, alkylether carboxylic acid salts, acylated peptides, alkylsulfonic acid salts, alkylbenzene and alkylnaphthalene sulfonic acid salts, sulfosuccinic acid salts, α-olefin sulfonic acid salts, N-acylsulfonic acid salts, sulfonated oils, alkylsulfonic acid salts, alkylether sulfonic acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylform-aldehyde condensed acid salts, alkylallylethersulfonic acid salts, alkylamidesulfonic acid salts, alkylphosphoric acid salts, alkyletherphosphoric acid salts, alkylallyletherphosphoric acid salts, alkyl and alkylallylpolyoxyethylene ethers, alkylallylform-aldehyde condensed polyoxyethylene ethers, blocked polymers having polyoxypropylene, polyoxyethylene polyoxypropylalkylethers, polyoxyethyleneether of glycolesters, polyoxyethyleneether of sorbitanesters, polyoxyethyleneether of sorbitolesters, polyethyleneglycol aliphatic acid esters, glycerol esters, sorbitane esters, propyleneglycol esters, sugar esters, fluoro C₂-C₁₀ alkylcarboxylic acids, disodium N-perfluorooctanesulfonyl glutamate, sodium 3-(fluoro-C₆-C₁₁-alkyloxy)-1-C₃-C₄ alkyl sulfonates, sodium 3-(ω-fluoro-C₆-C₈-alkanoyl-N-ethylamino)-1-propane sulfonates, N-[3-(perfluorooctanesulfonamide)-propyl]-N,N-dimethyl-N-carboxy-methylene ammonium betaine, fluoro-C₁₁-C₂₀ alkylcarboxylic acids, perfluoro-C₇-C₁₃-alkyl-carboxylic acids, perfluorooctane sulfonic acid diethanolamide, Li, K and Na perfluoro-C₄-C₁₂-alkyl sulfonates, N-propyl-N-(2-hydroxyethyl)perfluorooctane sulfonamide, perfluoro-C₆-C₁₀-alkylsulfonamide-propyl-sulfonyl-glycinates, bis-(N-perfluoro-octylsulfonyl-N-ethanolaminoethyl)phosphonate, mono-perfluoro C₆-C₁₆ alkyl-ethyl phosphonates, and perfluoroalkylbetaine.

Useful cationic surfactants include N-alkyl dimethyl ammonium chloride, palmityl trimethyl ammonium chloride, dodecyldimethylamine, tetradecyldimethylamine, ethoxylated alkyl guanidine-amine complex, oleamine hydroxypropyl bistrimonium chloride, oleyl imidazoline, stearyl imidazoline, cocamine acetate, palmitamine, dihydroxyethylcocamine, cocotrimonium chloride, alkyl polyglycolether ammonium sulphate, ethoxylated oleamine, lauryl pyridinium chloride, N-oleyl-1,3-diaminopropane, stearamidopropyl dimethylamine lactate, coconut fatty amide, oleyl hydroxyethyl imidazoline, isostearyl ethylimidonium ethosulphate, lauramidopropyl PEG-dimoniumchloride phosphate, palmityl trimethylammonium chloride, and cetyltrimethylammonium bromide. Especially useful are the fluorocarbon surfactants as described in e.g. U.S. Pat. No. 4,781,985, having a structure of: F(CF₂)₄₋₉CH₂CH₂SCH₂CH₂N⁺R₃X⁻ wherein R is a hydrogen or an alkyl group; and in U.S. Pat. No. 5,084,340, having a structure of: CF₃(CF₂)ₘCH₂CH₂O(CH₂CH₂O)ₙR wherein m=2 to 10; n=1 to 18; R is hydrogen or an alkyl group of 1 to 10 carbon atoms. These surfactants are commercially available from DuPont and 3M. The concentration of the surfactant component in the ink-receiving layer is typically in the range of 0.1 to 2%, preferably in the range of 0.4 to 1.5% and is most preferably 0.75% by weight based on the total dry weight of the layer.

### Ink Jet Inks

Ink jet inks suitable for use with the ink-jet receiving material according to the present invention typically include the following ingredients: dyes or pigments; water and/or organic solvents; humectants such as glycols; detergents; thickeners; polymeric binders; and preservatives. It will be readily understood that the optimal composition of such an ink is dependent on the ink jetting method used and on the nature of the substrate to be printed. Suitable ink compositions can be roughly divided in:

water based in which the drying mechanism involves absorption, penetration and evaporation;

oil based in which the drying involves absorption and penetration;

solvent based in which the drying mechanism mainly involves evaporation;

hot melt or phase change in which the ink vehicle is liquid at the ejection temperature but solid at room temperature and in which drying is replaced by solidification;

UV-curable in which drying is replaced by polymerization.

### Ink-Jet Printing

In ink jet printing tiny drops of ink fluid are projected directly onto an ink-receiving surface without physical contact between the printing device and the ink-receiving surface. The printing device stores the printing data electronically and provides a mechanism for ejecting the drops image-wise. Printing is accomplished by moving the print-head across the ink-receiving material or vice versa. Early patents on ink jet printers include U.S. Pat. No. 3,739,393, U.S. Pat. No. 3,805,273 and U.S. Pat. No. 3,891,121.

The jetting of the ink droplets can be performed in several different ways. In a first type of process a continuous droplet stream is created by applying a pressure wave pattern. This process is known as continuous ink jet printing. In a first embodiment the droplet stream is divided into droplets that are electrostatically charged, deflected and re-collected into droplets that remain uncharged, continue their way undeflected, and form the image. Alternatively, the charged deflected stream forms the image and the uncharged undeflected jet is re-collected. In this variant of continuous ink jet printing several jets are deflected to a different degree and thus record the image (multideflection system). According to a second process the ink droplets can be created “on demand” (“DOD” or “drop on demand” method) whereby the printing device ejects the droplets only when they are used in imaging on a receiver thereby avoiding the complexity of drop charging, deflection hardware, and ink recollection. In drop-on-demand the ink droplet can be formed by means of a pressure wave created by a mechanical motion of a piezoelectric transducer (so-called “piezo method”), or by means of discrete thermal pushes (so-called “bubble jet” method, or “thermal jet” method).

The ink dots that are applied to the ink-receiving layer should be substantially round in shape and smooth at their peripheries. The dot diameter must be constant and accurately controlled.

### Coating Techniques

The ink-receiving layers and the optional supplementary layers can be coated onto the support by any conventional coating technique, such as dip coating, knife coating, extrusion coating, spin coating, slide hopper coating and curtain coating.

The invention is illustrated hereinafter by way of comparative and invention examples. The percentages and ratios given in these examples are by weight unless otherwise indicated.

### EXAMPLES

Ingredients used in the ink-receiving layers of the Examples not mentioned above:

| | | | | Degree of | Viscosity of 4 |
|---|---|---|---|---|---|
| Polymer | | | Degree of | hydrolysis | wt % aqueous |
| nr. | Tradename | Supplier | polymerization | [mol %] | solution [mPa · s] |
| C1 | Celvol 540 | Celanese Corp. | | 87.0 to 88.0 | 45 to 55 |
| C2 | Celvol 523 | Celanese Corp. | | 87.0 to 89.0 | 23 to 27 |
| C3 | Celvol 205 | Celanese Corp. | | 87.0 to 89.0 | 5.2 to 6.2 |
| C4 | Poval 217 | Kuraray | 1700 | 87.0 to 89.0 | 20.5 to 24.5 |
| C5 | Poval 420 | Kuraray | 2000 | 78.0 to 81.0 | 37 to 45 |
| C6 | Poval 235 | Kuraray | 3500 | 87.0 to 89.0 | 80 to 110 |
| C7 | Erkol 40/140 | Acetex Europe | | 86.2 to 89.2 | 35 to 45 |

### Invention Examples 1 and 2 and Comparative Examples 1 to 7

Coating dispersions were prepared using different at least partially hydrolyzed copolymers comprising vinyl ester monomer units and ethylenically unsaturated cationic monomer units (INVENTION EXAMPLES 1 and 2) and different polyvinyl alcohols (COMPARATIVE EXAMPLE 1 to 7).

The coating dispersions consist of a binder, a fumed silica and boric acid. In this invention the binder is an at least partially hydrolyzed copolymers comprising vinyl ester and ethylenically unsaturated cationic monomer units. Copolymers nr 1 and 2 are copolymers of vinyl alcohol, vinyl acetate and diallyldimethyl-ammonium chloride. Hydrolyzed copolymers comprising vinyl ester and ethylenically unsaturated cationic monomer units were evaluated in comparison with polyvinyl alcohols from Air Products (USA) and Kuraray together with Celvol and Poval polyvinyl alcohols (see table below). The silica used was CAB-O-SPERSE® PG0022 from Cabot Corporation.

The coating dispersions comprise the following components:

| | |
|---|---|
| CAB-O-SPERSE ® PG022, a 20 wt % dispersion of silica = | 100 Parts |
| Copolymer or polymer (8.5% in water) = | 25 Parts |
| boric acid (4% in water) = | 7.5 Parts |

The coating dispersions were prepared as follows:

step 1): weighing the PVA and adjusting the pH to pH=3.7

step 2): addition of the silica dispersion under slow agitation

step 3): addition of the boric acid

The results of these coatings are given in Table 1.

From Table 1 it can be clearly seen that coatings without any cracking can be obtained with high molecular weight polyvinyl alcohols although at the expense of transparency, whereas high molecular weight at least partially hydrolyzed copolymers comprising vinyl ester monomer units and ethylenically unsaturated cationic monomer units give crack-free layers but with considerably higher transparency.

An additional disadvantage of high molecular weight polyvinyl alcohols is that the viscosities of the coating dispersions become very large and the coating latitude is minimal as shown by the fact that such coatings could only be coated on a lab-scale. When the boric acid is added the viscosity immediately becomes too high. The at least partially hydrolyzed copolymers comprising vinyl ester monomer units and ethylenically unsaturated cationic monomer units, such as Copolymer nr 1 and 2 give much lower coating dispersion viscosities.

In addition to the advantage of having a low coating dispersion viscosity, the coating dispersions containing the at least partially hydrolyzed copolymers comprising vinyl ester monomer units and ethylenically unsaturated cationic monomer units also offer the benefit that the coating dispersion has a longer shelf-life. In the case of the unmodified polyvinyl alcohols, the coating dispersion must be coated directly after addition of the boric acid. For the cationic vinylalcohol copolymer a very long pot-life (>several days) was obtained. A coating dispersion with silica Cabosperse PG0022, Copolymer nr 1 and boric acid (ratio 100/25/7.5 by weight) is still coatable after 5 days. This was impossible with the polyvinyl alcohols.

TABLE 1

| | | Viscosity of | Coating | Coating |
|---|---|---|---|---|
| | | coating dispersion | opacity | quality |
| Invention | Copolymer | | | |
| example nr. | nr. | | | |
| 1 | 1 | Low | transparent | Crack-free |
| 2 | 2 | Low | transparent | Crack-free |
| Comparative | Polymer | | | |
| example nr. | nr. | | | |
| 1 | C1 | High | Opaque | Crack-free |
| 2 | C2 | High | Opaque | Cracks |
| 3 | C3 | Low | Opaque | Cracks |
| 4 | C4 | High | Opaque | Cracks |
| 5 | C5 | High | Opaque | Cracks |
| 6 | C6 | High | Opaque | Cracks |
| 7 | C7 | High | Opaque | Cracks |

### Comparative Examples 8 and 9

### Examples with Alumina pigments, e.g. Al₂O₃

No advantage was observed upon replacing polyvinyl alcohol by an at least partially hydrolyzed copolymer comprising vinyl ester monomer units and ethylenically unsaturated cationic monomer units in a corresponding coating dispersion with an alumina pigment rather than sub-micron silica pigments. For example CAB-O-SPERSE® PG003, an Al₂O₃ pigment, can be used without a strong increase in viscosity upon addition of boric acid.

The present invention may include any feature or combination of features disclosed herein either implicitly or explicitly or any generalisation thereof irrespective of whether it relates to the presently claimed invention. In view of the foregoing description it will be evident to a person skilled in the art that various modifications may be made within the scope of the invention.

Having described in detail preferred embodiments of the current invention, it will now be apparent to those skilled in the art that numerous modifications can be made therein without departing from the scope of the invention as defined in the following claims.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Of course, variations of those preferred embodiments will become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

We claim:

1. An ink-receiving material comprising a support coated on at least one side with an ink-receiving layer, said ink-receiving layer containing sub-micron silica and an at least partially hydrolyzed copolymer comprising vinyl ester monomer units and ethylenically unsaturated cationic monomer units hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt.

2. Ink-receiving material according to claim 1, wherein said silica has a primary particle size between 4 and 60 nm.

3. Ink-receiving material according to claim 1, wherein said silica has an average agglomerated particle size smaller than 500 nm.

4. Ink receiving material according to claim 1, wherein said N,N-dialkenyl-N,N-dialkyl ammonium salt is diallyl dimethylammonium chloride.

5. Ink receiving material according to claim 1, wherein said at least partially hydrolyzed copolymer comprising vinyl ester monomer units and ethylenically unsaturated cationic monomer units is a terpolymer of vinyl alcohol, vinyl acetate and diallyl dimethylammonium chloride

6. Ink-receiving material according to claim 1, wherein said ink-receiving layer has a haze value of at most 45%.

7. Ink-receiving material according to claim 1, wherein said ink-receiving layer further comprises a further pigment.

8. Ink-receiving material according to claim 7, wherein said further pigment is selected from the group consisting of aluminosilicate, aluminium oxide, calcium carbonate, aluminium oxide hydrate, aluminum trihydroxide, and mixtures thereof.

9. Ink-receiving material according to claim 7, wherein said further pigment is an organic pigment.

10. Ink-receiving material according to claim 1, wherein said ink-receiving layer further comprises a further binder.

11. Ink-receiving material according to claim 10, wherein said further binder is polyvinyl alcohol.

12. Ink-receiving material according to claim 1, wherein said support is a transparent support.

13. Ink-receiving material according to claim 12, wherein said transparent support is a polyester support.

14. Ink-receiving material according to claim 1, wherein said support is a resin coated paper.

15. Ink-receiving material according to claim 1, wherein said material further comprises, on one or on both sides of the support, an adhesive layer incorporated between the support and the ink-receiving layer.

16. A process for the preparation of an ink-receiving material comprising the steps of: coating a support on at least one side with a dispersion containing sub-micron silica particles, an at least partially hydrolyzed copolymer comprising vinyl ester monomer units, ethylenically unsaturated cationic monomer units and boric acid or a borate, thereby preparing an ink-receiving layer hardened with boric acid or a borate, wherein said ethylenically unsaturated cationic monomer units is a quaternary ammonium salt or a quaternary phosphonium salt and said quaternary ammonium salt is an N,N-dialkenyl-N,N-dialkyl-ammonium salt.
